(19) United States
(12) Patent Application Publication
(10) Pub. No.: US 2003/0065789 A1
(43) Pub. Date: Apr. 3, 2003

(54) Seamless and authenticated transfer of a user from an e-business website to an affiliated e-business website

(76) Inventors: Gopinath Meghashyam, Portland, OR (US); Peter A. Nee, Beaverton, OR (US)

Correspondence Address: PILLSBURY WINTHROP, LLP, P.O. BOX 10500, MCLEAN, VA, 22102, US

(21) Appl. No.: 09/964,843

(22) Filed: Sep. 28, 2001

(51) Int. Cl. G06F 17/60; G06F 15/16; H04L 9/00

(52) U.S. Cl. 709/228; 705/1; 713/185

(57) ABSTRACT

An arrangement is provided for a seamless and authenticated transfer of a user from a main web site to an affiliated web site. A main web site may, after a user registers at the main web site, advise the user about an available service offered at an affiliated web site via a linking page with a ticket, which contains information related to the user. When the user chooses to connect to the available service at the affiliated web site, the ticket is seamlessly sent to the affiliated web site and is used to automatically verify the user before the affiliated web site provides the available service to the user.

### RESERVATION OF COPYRIGHT

This patent document contains information subject to copyright protection. The copyright owner has no objection to the facsimile reproduction by anyone of the patent document or the patent, as it appears in the U.S. patent and Trademark Office files or records but otherwise reserves all copyright rights whatsoever.

### BACKGROUND

Aspects of the present invention relate to Internet. Other aspects of the present invention relate to World Wide Web applications.

With the rapid advancement of the Internet, more and more companies develop web sites to advertise, to sale, and to provide services to their products. Users can log onto the web site of a company, browsing different lines of products that the company offers to sale, and examining various kinds of information related to the products. For example, by connecting to, for example, the web site of Dell Corporation, a user can gather not only the description and price of a Dell computer but also detailed technical specifications of the same. In addition, a company's web site may also provide links to the web sites of other affiliated companies for information related to the company's products. For example, the web site of Dell Corporation may have links to a web site of Intel Corporation, which may provide detailed information about various computer chips that are produced by Intel and used to build Dell computers.

Presently, each time when a user follows a link from one web site to a different web site, the user may be required to log in again at the transferred web site. For example, if a web site hosted by Dell Corporation provides customer services to its computer purchasers, it may require a customer to log in to obtain the services. During the login, the customer may be required to provide information such as user's identification, user's password, user's product serial number, etc. The Dell's web site may provide links to various web pages at a web site hosted by Intel Corporation (which is external to Dell). When a Dell customer follows, after log in at the Dell's web site, a link to get to an Intel web page, the customer is required to log in again. Furthermore, if the Intel web page also provides links to other web sites, the customer may be asked to log in many times. This repetitive log in processes may discourage a customer. In addition, it diminishes the usefulness and the efficiency that hyperlinks in a web page can provide.

### BRIEF DESCRIPTION OF THE DRAWINGS

The present invention is further described in terms of exemplary embodiments, which will be described in detail with reference to the drawings. These embodiments are non-limiting exemplary embodiments, in which like reference numerals represent similar parts throughout the several views of the drawings, and wherein:

FIG. 1 depicts a high-level architecture of a mechanism, which allows a main web site to transfer a user to an affiliated web site in a seamless and authenticated manner, according to embodiments of the present invention;

FIG. 2 is an exemplary flowchart of a process, in which a user is transferred from a main web site to an affiliated web site in a seamless and authenticated manner, according to embodiments of the present invention;

FIG. 3 depicts an exemplary internal structure of a main web site that facilitates seamless and authenticated transfer of a user to an affiliated web site, according to embodiments of the present invention;

FIG. 4 shows an exemplary construct of a ticket which is used to transfer a user from a main web site to an affiliated web site, according to an embodiment of the present invention;

FIG. 5 depicts an exemplary internal structure of an affiliated web site that facilitates seamless and authenticated transfer of a user from a main web site, according to embodiments of the present invention;

FIG. 6 is an exemplary flowchart of a process, in which a main web site transfers a user to an affiliated web site using a ticket, according to embodiments of the present invention;

FIG. 7 is an exemplary flowchart of a process, in which a ticket for transferring a user from a main web site to an affiliated web site is constructed and encoded, according to an embodiment of the present invention; and

FIG. 8 is an exemplary flowchart of a process, in which an affiliated web site accepts a transferred user by automatically authenticating a ticket and registering the user, according to an embodiment of the present invention.

### DETAILED DESCRIPTION

The invention is described below, with reference to detailed illustrative embodiments. It will be apparent that the invention can be embodied in a wide variety of forms, some of which may be quite different from those of the disclosed embodiments. Consequently, the specific structural and functional details disclosed herein are merely representative and do not limit the scope of the invention.

The processing described below may be performed by a properly programmed general-purpose computer alone or in connection with a special purpose computer. Such processing may be performed by a single platform or by a distributed processing platform. In addition, such processing and functionality can be implemented in the form of special purpose hardware or in the form of software being run by a general-purpose computer. Any data handled in such processing or created as a result of such processing can be stored in any memory as is conventional in the art. By way of example, such data may be stored in a temporary memory, such as in the RAM of a given computer system or subsystem. In addition, or in the alternative, such data may be stored in longer-term storage devices, for example, magnetic disks, rewritable optical disks, and so on. For purposes of the disclosure herein, a computer-readable media may comprise any form of data storage mechanism, including such existing memory technologies as well as hardware or circuit representations of such structures and of such data.

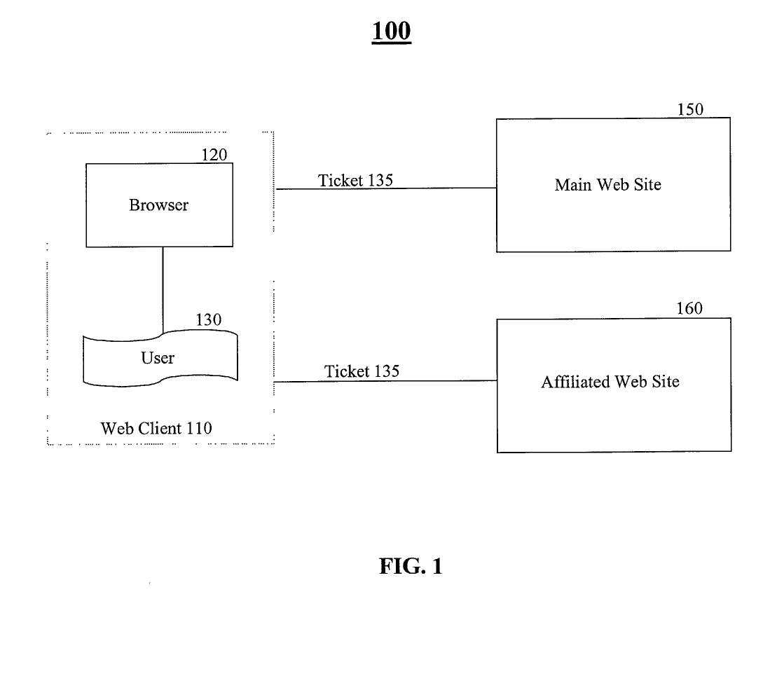

FIG. 1 depicts a high-level architecture of a mechanism 100, which allows a main web site 150 to transfer a user 130 to an affiliated web site 160 in a seamless and authenticated manner, according to embodiments of the present invention. The user 130 connects to a web site, either the main web site 150 or the affiliated web site 160, via a browser 120. The user 130 and the browser 120 together represent a web client 110.

In mechanism 100, the user 130 connects to the main web site 150 first. Upon receiving a connection request from the user 130 via the browser 120, the main web site 150 may authenticate the user 130. Once the connection is established, the main web site 150 advises the user 130 about an available service offered at the affiliated web site 160 by issuing a ticket 135, comprising a digital signature and information related to the user 130, to the user 130. The user 130 may then determine to utilize the available service at the affiliated web site 160 and connect to the affiliated web site 160 using the ticket 135. Upon receiveing the ticket 135, the affiliated web site 160 may authenticate the digital signature of the ticket 135 prior to registering the user 130 at the affiliated web site 160.

The main web site 150 represents a generic web site, which may provide online services to users. The main web site 150 is affiliated with one or more web sites (only one affiliated web site is shown in FIG. 1) that may offer additional and relevant online services. For example, the main web site 150 may correspond to a service web site of a corporation (e.g., Dell Corporation) and it may have links or references to service web sites of other corporations (e.g., Intel Corporation) that are external to the hosting environment of the main web site 150.

The affiliated web site 160 also represents a generic web site, which provides online services to users, who may connect to the affiliated web site 160 either independently or through a link or a reference initiated at the main web site 150. Similarly, the services offered by the affiliated web site may be independently provided to users or may be provided as additional services that are relevant to the services provided at the main web site 150. For instance, a web site hosted by Dell Corporation that provides technical support to its computer purchasers may have a link to another web site, hosted by Intel Corporation, that provides technical support to users who may have questions about the Intel chips used in Dell computers. In this case, the web site hosted at Dell Corporation is a main web site and the web site hosted by Intel Corporation is an affiliated web site.

The main web site 150, upon receiving a request from the user 130 to logon, may first perform necessary authentication of the user 130. The user 130 may be a new or an existing user of the main web site 150. When it is a new user, information about a new user may be collected during the initial registration and the collected information may be stored at the main web site 150 for future authentication purposes. Examples of such information include user's identification and user's preferences such as language preference. During an initial registration process, the main web site 150 may also assign certain privilege terms to the user.

If the user 130 is an existing user, the main web site 150 may perform authentication against pre-stored information related to the user 130. Such pre-stored information may include verification of the user's password, product serial number, or the user's privilege. For example, based on the pre-stored information related to the user 130, the main web site 150 may verify the password of the user or whether the user 130 has the privilege for the requested service. The verification process may also determine how the main web site 150 can server the user 130. For example, a user's language preference may be used to control how a web page is to be rendered.

During a connected browsing session with the user 130, the main web site 150 may advise the user 130 about an available service offered at the affiliated web site 160. This may be achieved by providing a link or reference to the affiliated web site 160, wherein the link may be implemented to appear on a linking page specifically designed to advertise the available service. Through this link, the user 130 may choose to utilize the available service. To facilitate the user's request to utilize the available service, the main web site 150 issues a ticket that allows the user to enter the affiliated web site directly without having to manually logon to the affiliated web site 160.

The ticket 135 may represent a collection of information necessary to automatically authenticate and register the user 130 at the affiliated web site 160. For example, it may comprise a digital signature and the information related to the user such as the user's identification, the user's preference information, or the user's privilege information. A digital signature may be used to signify a trusted source of reference. For example, from a digital signature of a ticket, the source of the ticket may be recognized. In mechanism 100, a digital signature of the ticket 130 may be the signature of the main web site 150 or a digital signature generated with a user-specific key held at the main web site 150 or it may comprise both.

The ticket 135 contains sufficient information to authenticate the user 130 at the affiliated web site 160. The ticket 135 contains the user's identification and the digital signature verifies that the main web site 130 has already authenticated the user's identity. That is, through the ticket 135, the affiliated web site 160 can extract useful information such as user's identification and password, that is necessary to authenticate the user 130. Other types of information may also be included in the ticket 135. For example, user's preferences (e.g., preferred language used to display a web page) and user's privileges (e.g., specifying the level of service subscribed) may be included so that the affiliated web site 160 can utilize such information to render available services accordingly.

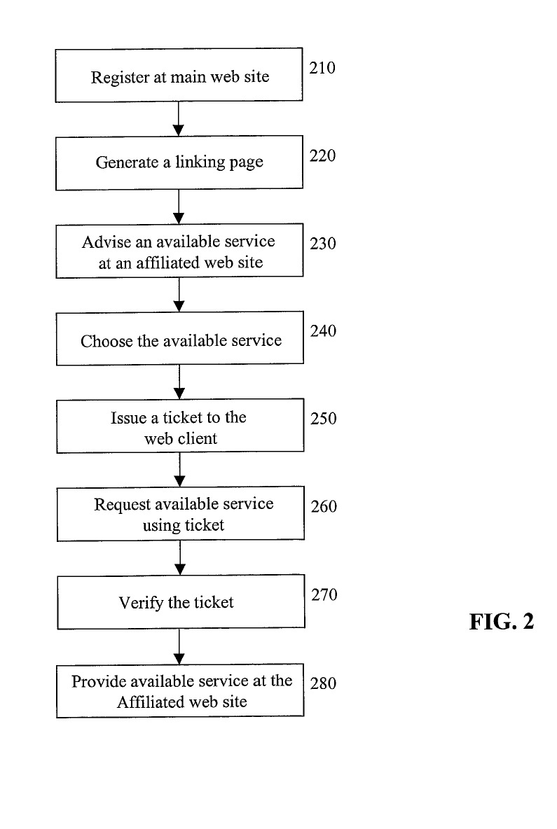

FIG. 2 is an exemplary flowchart of a process, in which a user 130 is transferred from a main web site 150 to an affiliated web site 160 in a seamless and authenticated manner, according to embodiments of the present invention. The user 130 first registers at the main web site 150 at act 210. Upon registering the user 130, the main web site 150 generates, at act 220, a linking page that is then applied, at act 230, to advise the user 130 about an available service offered at the affiliated web site 160.

When the user 130 chooses, at act 240, the available service, the main web site 150 issues, at act 250, a ticket to the user 130. Using the ticket issued from the main web site 150, the user 130 requests, at act 260, the available service. When the affiliated web site 160 receives the request, it verifies, at act 270, the authenticity of the ticket. Once the ticket is authenticated, the affiliated web site 160 provides, at act 280, the available service to the user 130.

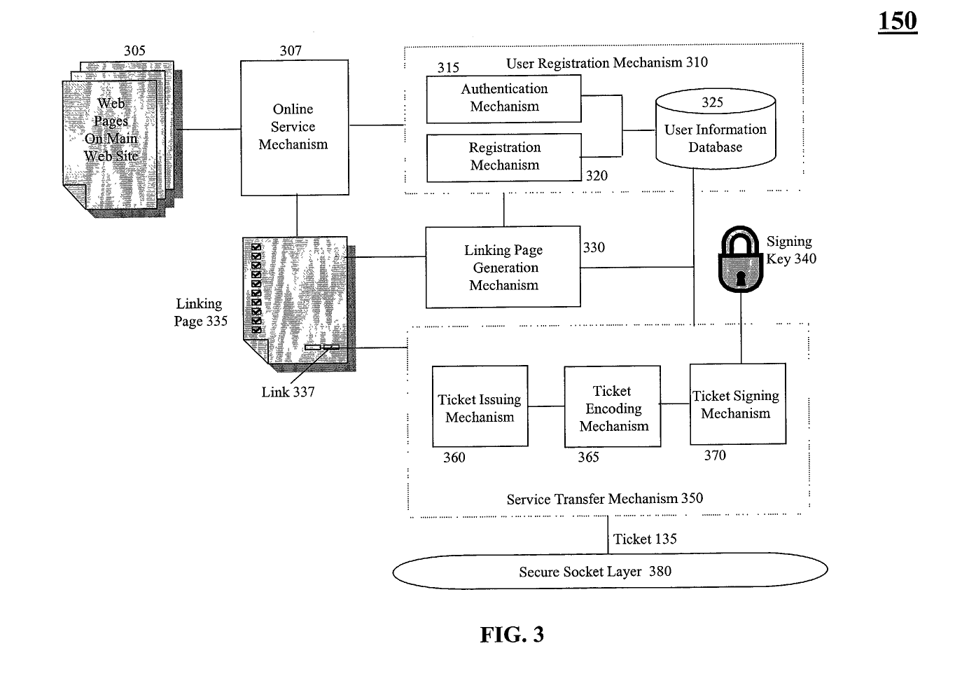

FIG. 3 depicts an exemplary internal structure of the main web site 150 that facilitates seamless and authenticated transfer of a user to the affiliated web site 160, according to embodiments of the present invention. The main web site 150 comprises a plurality of web pages 305, a user registration mechanism 310, an online service mechanism 307, a linking page generation mechanism 330, a service transfer mechanism 355, a signing key 340, and a secure socket layer 380. The user registration mechanism 310 registers a user who requests a service at the main web site 150. Necessary authentication may be performed as part of the registration. Once the user is registered, the online service mechanism 307 provides services to the user by, for example, displaying web pages 305. During the service, the linking page generation mechanism 330 generates a linking page with a link to an available service at the affiliated web site 160. The linking page is subsequently used by the online service mechanism 307 to advertise an available service. If the user choose to use the available service by activating the link, the main web site 150 issues a ticket for transferring the user to the affiliated web site 160.

The user registration mechanism 310 comprises a user information database 325, an authentication mechanism 315, and a registration mechanism 320. The user information database 325 stores information about users of the main web site 150. Such information may include user's identification, user's password, user's preferences, and user's access privileges and can be retrieved for different purposes. For example, a user's password may be retrieved for authenticating the user. User's language preference may be obtained from the user information database 325 to determine how the online service mechanism 307 should render a web page. User's privileges may be used to restrict the access of certain web pages, corresponding to certain services, at the main web site 150.

The authentication mechanism 315 authenticates a user. Authentication may be performed according to the information stored in the user information database 325, if the user 130 is an existing user. In this case, information related to the user may be retrieved based on user's identification (e.g., login name) and the retrieved information includes the information (e.g., password) to be used to authenticate the user 130. Once the user 130 is authenticated, the registration mechanism 320 may proceed to register the user 130. Registering an existing user may include recording the current request and updating the user information database if the current information related to the user 130 is different from the information related to the user 130 presently stored in the user information database 325.

If the user is a new user (e.g., the user's identification can not be found in the user information database 325), the registration mechanism 320 may be invoked directly to register the new user. In this case, the registration mechanism 320 may acquire necessary information from the new user, which may include the user's chosen password. Other types of information related to the user may also be acquired such as desired services and the user's preferences in terms of how services may be rendered (e.g., preferred language used to display web pages when services are offered). The acquired user's information may then be stored in the user information database 325. The stored information may be properly indexed (e.g., according to user's identification) so that when needed, the information may be retrieved efficiently.

The web pages 305 may constitute the display content of the services offered at the main web site 150. The online service mechanism 307 may render the web pages 305 according to the user's preferences such as a particular language preference. During the process of servicing the user, the main web site 150 may, at appropriate point, advise the user 130 about an available service (or available services) offered at the affiliated web site 160. To facilitate that, the linking page generation mechanism 330 generates a linking page 335 which contains a link 337 through which the user may connect directly to the affiliated web site 160.

The link 337 may be implemented as a universal resource locator (URL) address, representing the location of the affiliated web site 160. If interested in the available service, the user may simply click on the link 337 to connect to the available service. The link 337 may be associated with the ticket 135, which may be designed to facilitate a seamless service transfer. The ticket is generated by the service transfer mechanism 350, which, as depicted in FIG. 3, comprises a ticket issuing mechanism 360, a ticket encoding mechanism 365, and a ticket signing mechanism 370.

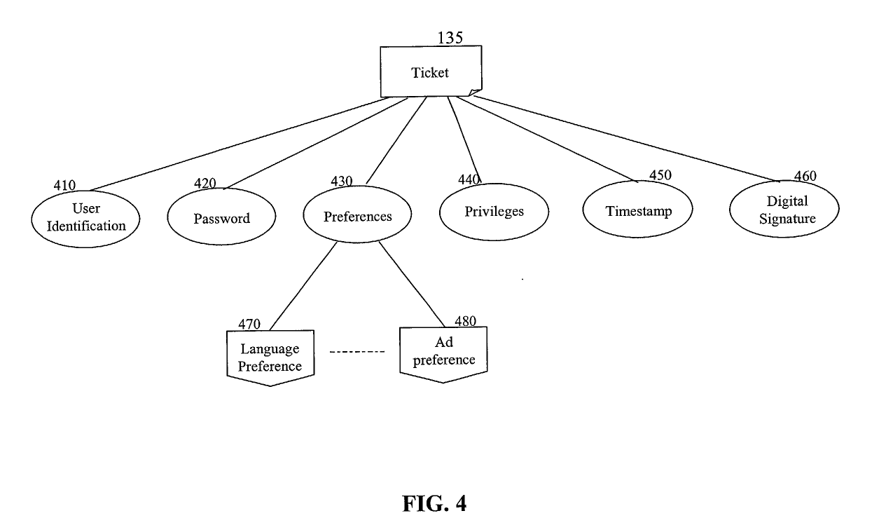

The ticket issuing mechanism 360 generates the ticket 135. The ticket 135 represents a transfer authorization and it may contain different types of information needed for the affiliated web site 160 to perform authentication and registration. In FIG. 4, an exemplary construct of a ticket is shown. The ticket 135 includes user's identification 410, user's preferences 430, user's privileges 440, a timestamp 450, and a digital signature 460. The user's identification 410 indicates to whom the ticket 135 is issued to. The digital signature 460 provides an assurance that the identity of the user has already been verified at the main web site 150. Basedon the trust relationship between the main web site 150 and the affiliated web site 160, and on the shared secret of the signing key 340 and the verifying key 525, the affiliated web site 160 may automatically authenticate an existing user without prompting for a password or other authentication data. This streamlines the authentication process for an existing user.

Other types of information (related to the user) incorporated in the ticket 135 may also facilitate seamless and efficient services at the affiliated web site 160. For example, user's preferences 430, such as language preference 470 and advertisement preference 480, may be used by the affiliated web site 160 to determine how to render its services to the transferred user 130. Based on the language preference 470, services may be offered in a specified preferred language. Based on the advertisement preference 480, the affiliated web site 160 may select only those categories of advertisement that are consistent with the user's preferred advertisement and render such selected advertisement in web pages.

When the ticket 135 is issued, the ticket issuing mechanism 360 may attach the timestamp 450 to the ticket 135 to specify the time by which the ticket is issued. The timestamp 450 may have different uses. For example, it may be used to determine the validity of the ticket: the affiliated web site 160 may consider a ticket issued 30 minutes ago as invalid. The authentication criteria adopted at the affiliated web site 160 may be application dependent. Consequently, what types of information should be incorporated in the ticket 135 may also be determined based on the specific needs of underlying applications.

The ticket signing mechanism 370 incorporates the digital signature 460 in the ticket 135. The digital signature 460 may be generated based on the signing key 340. The digital signature 460 may serve as a transfer authorization stamp placed by the main web site 150 on the ticket 135. The signing key 340 used to generate the digital signature 460 may correspond to the private key of a public/private key pair agreed between the main web site 150 and the affiliated web site 160. With the digital signature 460, the affiliated web site 160 can verify the authenticity of the ticket using the public key of the agreed public/private key pair so that to make sure that the underlying transfer through such a signed ticket is indeed issued from a valid affiliated web site.

The ticket encoding mechanism 365 encodes the ticket 135. The encoding may include, for instance, organizing different types of information contained in the ticket according to some agreed structure. The ticket encoding mechanism 365 may also determine an appropriate means to transfer the ticket 135. For example, the ticket 135 may be coded as a parameter in the URL address corresponding to the link 337. Alternatively, the ticket 135 may also be coded as part of an in-memory cookie.

The ticket encoding mechanism 365 may select an encoding scheme, among possibly a plurality of supported encoding options, that is suitable for a specific transfer. That is, the ticket encoding mechanism 365 may determine an encoding scheme on-fly based on certain criteria. For example, the encoding scheme of incorporating the ticket 135 as part of an in-memory cookie may be employed when the main web site 150 and the affiliated web site 160 are in the same domain. Alternatively, the encoding scheme of incorporating the ticket 135 as a parameter of a URL address may be employed when the main web site 150 and the affiliated web site 160 are not in the same domain.

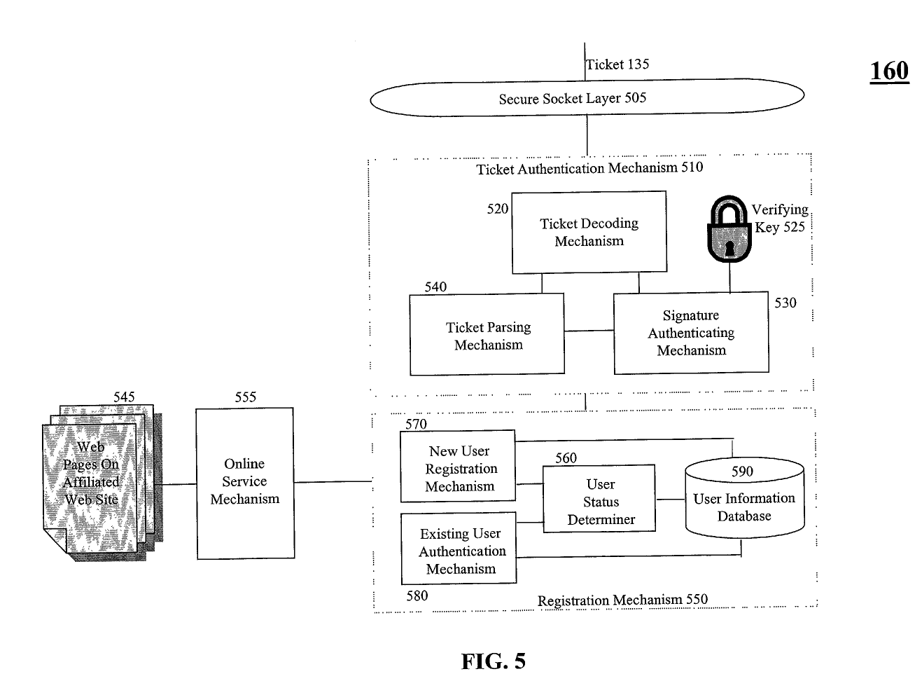

FIG. 5 depicts an exemplary internal structure of the affiliated web site 160 that facilitates a seamless and authenticated transfer of a user from the main web site 150, according to embodiments of the present invention. The affiliated web site 160 comprises a secure socket layer 505, a ticket authentication mechanism 510, a registration mechanism 550, an online service mechanism 555, and a plurality of web pages 545. The affiliated web site 160 receives a transfer ticket 135 via the secure socket layer 505. Upon receiving the transfer ticket 135, the ticket authentication mechanism 510 verifies the authenticity of the ticket 135, decodes the ticket 135, and parses the ticket 135 to extract distinct types of information. The registration mechanism 550 then utilizes the user's information extracted from the ticket 135 to automatically authenticate the transferred user. If the user is authenticated, the online service mechanism 555 renders online services through the web pages 545.

The ticket authentication mechanism 510 comprises a ticket decoding mechanism 520, a signature authenticating mechanism 530, a verifying key 525, and a ticket parsing mechanism 540. The ticket decoding mechanism 520 first decodes the ticket 135. For example, if a ticket is encoded as a parameter in a URL address, the ticket decoding mechanism 520 identifies and extracts the ticket from the URL address. If a ticket is encoded as part of a cookie, the ticket decoding mechanism 520 identifies and extracts the ticket from the cookie. The extracted ticket contains different types of information such as digital signature, user's identification and password, or user's preferences.

Before the transferred user can be registered at the affiliated web site 160, the ticket 135 may need to be authenticated. That is, the affiliated web site 160 may need to make sure that the ticket is from a reliable source. To do so, the signature verifying mechanism 530 authenticates the digital signature of the ticket 135 using the verifying key 525, which may correspond to the public key of a public/private key pair that is agreed between the main web site 150 and the affiliated web site 160. If the main web site 150 issues the ticket 135 using the signing key 340, the affiliated web site 160 should be able to use the verifying key 525 to decode the digital signature. If the digital signature in the ticket 135 can not be decoded using the verifying key 525, the ticket 135 may be from a different (may be fraudulent) source.

After the ticket 135 is authenticated, the ticket parsing mechanism 540 parses the ticket and extracts different kinds of information contained in the ticket 135. As illustrated in FIG. 4, the ticket 135 may include different categories of information that are necessary and useful for the affiliated web site 160 to either authenticate the user or to appropriately render online services according to the information related to the user (e.g., language and advertisement preferences). The parsed information is fed to the registration mechanism 550.

The registration mechanism 550 authenticates and registers, once authenticated, a user at the affiliated web site 160. The registration mechanism 550 may deal with both a transferred user and a user who logs on the affiliated web site 160 independently. The registration may be performed based on various kinds of information relevant to the user such as user's identification and user's preferences. For a user who logs on the affiliated site independently, information such as a password may also be used during the registration for, for example, authentication purposes. As depicted in FIG. 5, the registration mechanism 550 at the affiliated web site 160 includes a user status determiner 560, a new user registration mechanism 570, an existing user registration mechanism 580, and a user information database 590.

The user status determiner 560 examines whether a user is a new or an existing user. The user's identification extracted from the ticket 135 may be used to make the decision. For example, based on the extracted user's identification, the user status determiner 560 may retrieve the corresponding user's information from the user information database 590, using the user's identification as an index during the retrieval. If no information can be retrieved using the user's identification, it may indicate that the user is a new user. If information related to the same user can be retrieved from the user information database 590, it may indicate that the user is an existing user. If the current user is a new user, the user status determiner 560 may invoke the new user registration mechanism 570 to register the user at the affiliated web site 160.

When the new user registration mechanism 570 is activated, it utilizes the information extracted from the ticket 135 to register the new user. This may include use of the user's identification as an index to store other types of user's information in the user information database 590. By doing so, such stored user's information may be retrieved in the future based on the user's identification. Information extracted from the ticket 135 may be stored in a structure with certain categories. For example, the user's preferences may be stored as personalized profile so that the affiliated web site 160 can appropriately personalize online services according to the user specified preferences.

If the transferred user is an existing user, the user status determiner 560 may further examine whether the current user's information is different from the user's information stored in the user information database 590. For example, it may examine whether the user currently has different preferences or whether the user's privileges have been changed (e.g., the main web site 150 may have recently upgraded the user's privileges). The user status determiner 560 may then invoke the existing user registration mechanism 580 to register the existing user with notification about the discrepancies between the current user information and stored user information.

When the existing user authentication mechanism 580 is activated for a user with a valid ticket, it automatically authenticates the user 130 without further input.

In the mechanism 100, the main web site 150 and the affiliated web site 160 are associated with each other. Information about their common users stored in the user information database 325 at the main web site 150 and the user information database 590 at the affiliated web site 160 may need to be synchronized. Any discrepancy in user data may indicate that the two web sites are not synchronized. In this case, the existing user registration mechanism 580 may react accordingly. For example, it may update the user's information in the user information database 590 based on the information extracted from the ticket 135. Whether the affiliated web site 160 permits a transferred user with discrepancy to register may be implemented according to application needs. For example, if a transferred user has different privileges specified in the ticket 135 than in the user information database 590, the existing user registration mechanism 570 may update the privileges in the user database 590 to match the ticket 135, ignore the privileges in the in the tocket 135 and only grant those privileges in the user information database 590, combine the two sets of privileges in some way, or deny the user access to the site altogether. For applications where the user information database 590 is not updated from data in the ticket 135, a secure offline process may be used for direct synchronization between the user information database 325 at the main web site 150 and the user information database 590 at the affiliated web site 160.

Discrepancies in other kinds of information, which although may not be considered as equally crucial, may also trigger the existing user registration mechanism 580 to update the user information database 590. Examples of such information includes user's preferences. Some discrepancies may not raise security issues. When such discrepancies are detected, they can be used to update the stored information so that the affiliated web site 160 can serve the user in a consistent and effective fashion.

The online service mechanism 555 is activated once the registration is completed. It provides the online services available at the affiliated web site 160 to the user and offers such services by displaying the web pages 545 in an appropriate form that is consistent with the user's preferences and privileges.

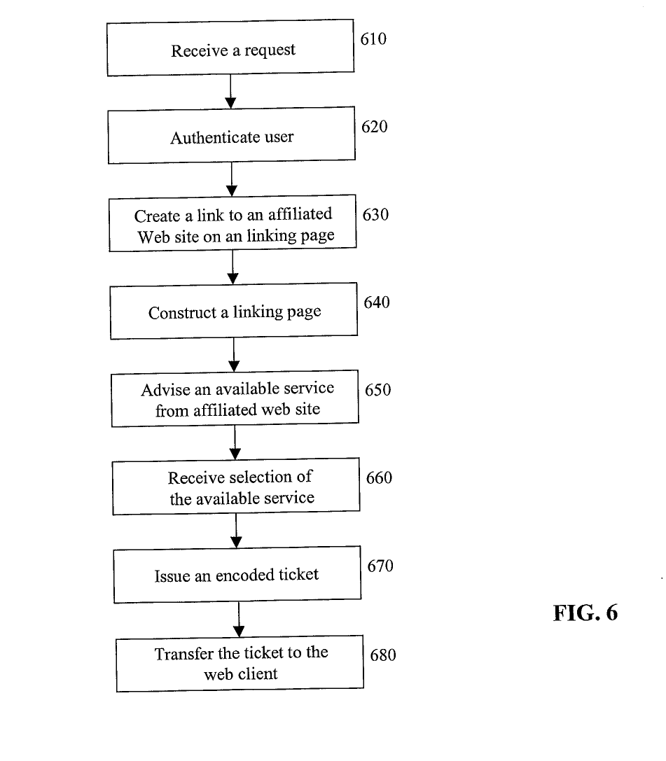

FIG. 6 is an exemplary flowchart of a process, in which the main web site 150 transfers the user 130 to the affiliated web site 160 using the ticket 135, according to embodiments of the present invention. A request is first received, at act 610, from the user 130 to connect to the main web site 150. The main web site 150 then authenticates the user at act 620. Once the user is authenticated, the main web site 150 creates, at act 630, a link to the affiliated web site that hosts an available service and further constructs, at act 640, a linking page. The available service is advised, at act 650, to the user during the interaction between the user 130 and the main web site 150.

The user 130, upon receiving the linking page that advertises the available service offered at the affiliated web site 160, may select to connect to the affiliated web site 160. The user 130 may make the selection by clicking on the link in the linking page. When the selection is received, at act 660, the main web site 150 issues a ticket 130, at act 670, representing an authorize a transfer, which is performed at act 670, of the user 130 from the main web site 150 to the affiliated web site 160.

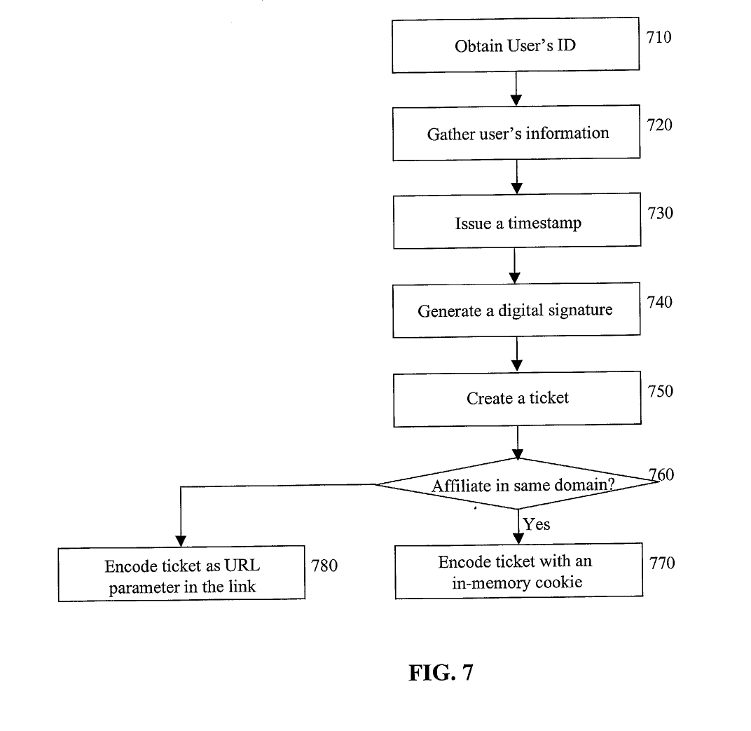

To generate a ticket, the service transfer mechanism 350 gathers various types of information to facilitate a seamless and authenticated transfer. FIG. 7 is an exemplary flowchart of a process, in which the ticket 135 authorizing a transfer of a user 130 at the main web site 150 to the affiliated web site 160 is constructed and encoded to facilitate a seamless and authenticated transfer, according to an embodiment of the present invention. The service transfer mechanism 350 first obtains, at act 710, the user's identification. Based on the user's identification, information related to the user is gathered, at act 720. Such information may include user's preferences and privileges. A timestamp is issued at act 730 to mark the time by which the ticket 135 is issued.

To allow the affiliated web site 160 to authenticate the source of the ticket 135, the service transfer mechanism 350 generates, at act 740, a digital signature for the ticket 135. Based on the user's information, the timestamp, and the digital signature, the ticket 135 is constructed at act 750. To encode the ticket 135, it is examined, at act 760, whether the affiliated web site 160 is in the same domain as the main web site 150. If both web sites are within the same domain, the ticket 135 is encoded, at act 770, as part of an in-memory cookie. Otherwise, the ticket 135 is encoded, at act 780, as a parameter of the URL address linking to the affiliated web site 160.

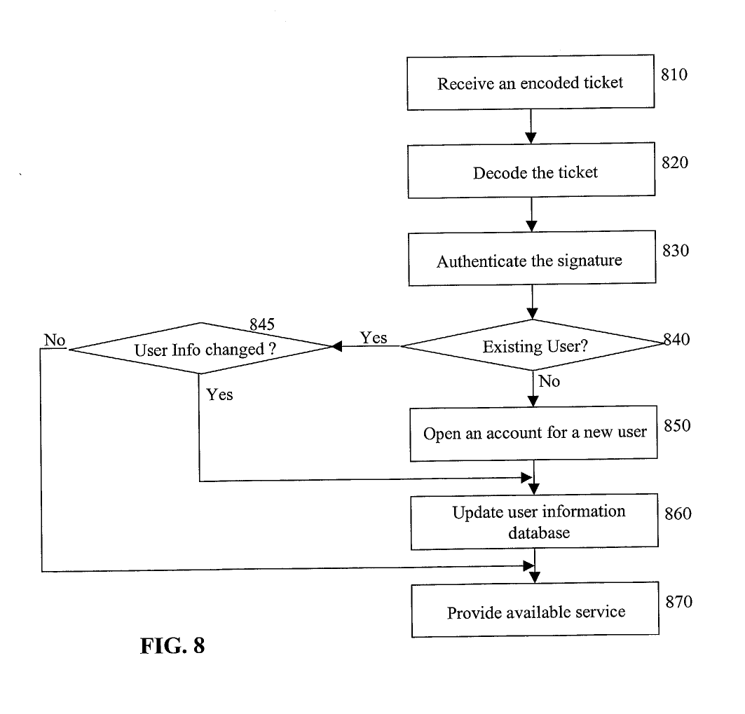

FIG. 8 is an exemplary flowchart of a process, in which the affiliated web site 160 provides online service to a user that is transferred from the main web site 150 in a seamless fashion, according to an embodiment of the present invention. The affiliated web site 160 receives, at act 810, an encoded ticket 135, which is then decoded at act 820. The digital signature of the ticket 135 is authenticated at act 830. If the ticket is verified from the main web site 150, the affiliated web site 160 further examines, at act 840, whether the transferred user corresponds to a new or an existing user.

If the transferred user is a new user, the affiliated web site 160 opens, at act 850, a new account for the user. The information about the user extracted from the ticket 135 is then used to update the user information database 590 at the affiliated web site 160. If the transferred user corresponds to an existing user, the affiliated web site 160 further examines, at act 845, whether any relevant user's information has been changed. This is performed with respect to the existing user's information stored in the user information database 590. If discrepancies are detected, the user information database 590 is updated, at act 860, to incorporate the most recent information about the user. After the user is registered with updated information, the affiliated web site 160 provides, at act 870, the available service to the transferred user.

While the invention has been described with reference to the certain illustrated embodiments, the words that have been used herein are words of description, rather than words of limitation. Changes may be made, within the purview of the appended claims, without departing from the scope and spirit of the invention in its aspects. Although the invention has been described herein with reference to particular structures, acts, and materials, the invention is not to be limited to the particulars disclosed, but rather extends to all equivalent structures, acts, and, materials, such as are within the scope of the appended claims.

What is claimed is:

1. A method, comprising:
registering a user from a browser, at a main web site;
generating, at the main web site, a linking page, containing a link to an affiliated web site;
advising the user about an available service offered at the affiliated web site, which can be reached through the link;
choosing, by the user, to connect to the affilated web site for the available service through activating the link on the linking page;
issuing, by the main web site, upon on the link being activated, a ticket, to the user, encoded with different kinds of information related to the user;
requesting, by the user, the available service at the affiliated web site using the ticket;
verifying, at the affiliated web site, the ticket transferred from the main web site; and
providing the available service to the user if the verifying the ticket is successful.

2. The method according to claim 1, wherein the issuing a ticket comprises:
gathering information related to the user;
issuing a timestamp;
generating a digital signature of the ticket;
creating the ticket based on the information related to the user, the timestamp, and the digital signature; and
encoding the ticket.

3. The method according to claim 2, wherein the verifying the ticket comprises:
decoding the ticket; and
authenticating the digital signature of the ticket.

4. A method for a main web site, comprising:
receiving a request from a user through a bowser;
authenticating the user based on information stored at the main web site;
generating, at the main web site, a linking page, containing a link to an affiliated web site;
advising, through the linking page, the user about an available service offered at the affiliated web site, which can be reached through the link;
receiving, from the user, a choice to connect to the affiliated web site for the available service;
issuing, upon receiving the choice of connecting to the available service, a ticket encoded with different kinds of information related to the user and to be used by the user to request the available service at the affiliated web site; and
transfering the ticket from the main web site to the user.

5. The method according to claim 4, wherein the issuing the ticket comprises:
determining the user's identification;
gathering information related to the user;
issuing a timestamp;
generating a digital signature of the ticket;
creating the ticket based on the information related to the user, the timestamp, and the digital signature; and
encoding the ticket.

6. The method according to claim 5, wherein the gathering the information related to the user includes at least one of:
retrieving the user's information from a user information database at the main web site based on the user's identification; and
obtaining the user's information from the user.

7. The method according to claim 6, wherein gathering the user's information includes:
gathering users language preference.

8. The method according to claim 5, wherein the encoding the ticket includes at least one of:
encoding the ticket in a cookie, if the affiliated web site is in the same domain as the main web site; and
encoding the ticket as a parameter of a universal resource locator address representing the location of the affiliated web site, if the affiliated web site is not in the same domain as the main web site.

9. A method for an affiliated web site, comprising:
receiving, a request from a user with a ticket comprising a digital signature and information related to the user;
authenticating the digital signature of the ticket;
decoding the ticket, after the digital signature is authenticated by the autnenticating, to extract information related to the user;
registering the user based on the information related to the user; and
providing an available service offered at the affiliated web site to the user.

10. The method according to claim 9, wherein the information related to the user includes at least one of:
user's identification;
user's preferences; and
user's privilages.

11. The method according to claim 10, wherein the user's preferences include user's language preference.

12. The method acording to claim 11, wherein the registering the user comprises:
determining, using the user's identification, whether the user is a new user, with respect to the information stored in a user's information database at the affiliated web site;
determining whether a new account should be opened for the user if the user is identified as a new user;
opening a new account for the user if it is determined that a new account should be opened for a new user;
authenticating, if the user is not a new user, using the information related to the user stored in the user information database;
determining, if the user is authenticated by the authenticating, whether the information related to the user decoded from the ticket is different from the information related to the user stored in the user's information database at the affiliated web site; and
updating the user's information database based on the information related to the user decoded from the ticket, if either the user is a new user or the information in the user information database at the affiliated web site is different from the information related to the user decoded from the ticket.

13. A system, comprising:
a main web site for offering online services;
a web client comprising a browser and a user communicating with the main web site through the browser for the services;
an affiliated web site affiliated with the main web site for offering a service that can be advised to the user through the main web site and that can be provided to the user when the main web site transfers the user to the affiliated web site with a ticket containing information related to the user and a digital signature.

14. The system according to claim 13, wherein the main web site comprises:
a user registration mechanism for registering the user at the main web site when the user connects to the main web site via the browser;
a linking page generation mechanism for generating a linking page that contains a link to the affiliated web site and that is to be used to advise the user about an available service offered at the affiliated web site, which can be reached through the link;
an online service mechanism for providing the online services to the user; and
a service transfer mechanism for issuing the ticket to the user when the user chooses, through the linking page, to connect to the affiliated web site for the available service, the ticket enabling the user to connect to the affiliated web site without the need to enter the information related to the user.

15. The system according to claim 14, wherein the affiliated web site comprises:
a ticket authentication mechanism for authenticating the ticket received from the user to request the available service;
a regiatration mechanism for registering the user, after the authenticating the ticket, at the affiliated web site; and
an online service mechanism for providing the user the available service.

16. A system for a main web site, comprising:
a user registration mechanism for registering a user, requesting to connect to the main web site via a browser;
a linking page generation mechanism for generating a linking page that contains a link to an affiliated web site and that is to be used to advise the user about an available service offered at the affiliated web site, which can be reached through the link;
an online service mechanism for providing online services to the user; and
a service transfer mechanism for issuing a ticket to the user when the user chooses, through the linking page, to connect to the affiliated web site for the available service, the ticket enabling the user to connect to the affiliated web site without the need to enter the information related to the user.

17. The system according to claim 16, wherein the registration mechanism comprises:
a user information database for storing the information related to users of the main web site;
an authentication mechanism for authenticating the user based on the information stored in the user information database and the information entered by the user with the requesting; and
a registration mechanism for registering the user at the main web site, provided that the user is considered authenticate by the authenticating, and for updating the information related to the user in the user information database according to the informtion provided with the requesting.

18. The system according to claim 17, wherein the service transfer mechanism comprises:
a ticket issuing mechanism for issuing the ticket based on the information related to the user;
a ticket signing mechanism for generating a digital signature based on a signing key for the ticket; and
a ticket encoding mechanism for encoding the ticket with the digital signature.

19. A system for an affiliated web site, comprising:
a ticket authentication mechanism for authenticating a ticket received from a user to request an available service at the affiliated web site, the ticket comprising information related to the user and a digital signature;
a regiatration mechanism for registering the user, after the authenticating the ticket, at the affiliated web site based on the information related to the user included in the ticket; and
an online service mechanism for providing the available service to the user.

20. The system ccording to claim 19, wherein the ticket authentication mechanism comprises:
a signature authenticating mechanism for authenticating the digital signature of the ticket using a verifying key;
a ticket decoding mechanism for, after the digital signature of the ticket is authenticated, decoding the ticket; and
a ticket parsing mechanism for, after the ticket is decoded, parsing the ticket to extract the information related to the user.

21. The system according to claim 20, wherein the registration mechanism comprises:
a user status determiner for determining whether the user is a new user or an existing user or whether the information related to the user encoded in the ticket is different from the information related to the user stored in the user information database at the affiliated web site;
a new user registration mechanism for, if the user is a new user, registering the user as a new user based on the information related to the user extracted from the ticket; and
an existing user registration mechanism for registering an existing user, including authenticating the existing user, registering the existing user, and updating the information related to the existing user stored in the user information database, if the extracted information related to the user is different from the information related to the user stored in the user information database.

22. A computer-readable medium encoded with a program, the program, when executed, causing:
registering a user from a browser, at a main web site;
generating, at the main web site, a linking page, containing a link to an affiliated web site;
advising the user about an available service offered at the affiliated web site, which can be reached through the link;
choosing, by the user, to connect to the affilated web site for the available service through activating the link on the linking page;
issuing, by the main web site, upon on the link being activated, a ticket, to the user, encoded with different kinds of information related to the user;
requesting, by the user, the available service at the affiliated web site using the ticket;
verifying, at the affiliated web site, the ticket transferred from the main web site; and
providing the available service to the user if the verifying the ticket is successful.

23. The medium according to claim 22, wherein the issuing a ticket comprises:
gathering information related to the user;
issuing a timestamp;
generating a digital signature of the ticket;
creating the ticket based on the information related to the user, the timestamp, and the digital signature; and
encoding the ticket.

24. The medium according to claim 23, wherein the verifying the ticket comprises:
decoding the ticket; and
authenticating the digital signature of the ticket.

25. A computer-readable medium encoded with a program for a main web site, the program, when executed, casing:
receiving a request from a user through a bowser;
authenticating the user based on information stored at the main web site;
generating, at the main web site, a linking page, containing a link to an affiliated web site;
advising, through the linking page, the user about an available service offered at the affiliated web site, which can be reached through the link;
receiving, from the user, a choice to connect to the affiliated web site for the available service;
issuing, upon receiving the choice of connecting to the available service, a ticket encoded with different kinds of information related to the user and to be used by the user to request the available service at the affiliated web site; and
transfering the ticket from the main web site to the user.

26. The medium according to claim 25, wherein the issuing the ticket comprises:
determining the user's identification;
gathering information related to the user;
issuing a timestamp;
generating a digital signature of the ticket;
creating the ticket based on the information related to the user, the timestamp, and the digital signature; and
encoding the ticket.

27. The medium according to claim 26, wherein the encoding the ticket includes at least one of:
encoding the ticket in a cookie, if the affiliated web site is in the same domain as the main web site; and
encoding the ticket as a parameter of a universal resource locator address representing the location of the affiliated web site, if the affiliated web site is not in the same domain as the main web site.

28. A computer-readable medium encoded with a program for an affiliated web site, the program, when executed, causing:
receiving, a request from a user with a ticket comprising a digital signature and information related to the user;
authenticating the digital signature of the ticket;
decoding the ticket, after the digital signature is authenticated by the autnenticating, to extract information related to the user;
registering the user based on the information related to the user; and
providing an available service offered at the affiliated web site to the user.

29. The medium according to claim 28, wherein the registering the user comprises:
determining, using the user's identification, whether the user is a new user with respect to the information stored in a user's information database at the affiliated web site;
determining whether a new account should be opened for the user if the user is identified as a new user;
opening a new account for the user if it is determined that a new account should be opened for a new user;
authenticating, if the user is not a new user, the user using the information related to the user stored in the user information database;
determining, if the user is authenticated by the authenticating, whether the information related to the user decoded from the ticket is different from the information related to the user stored in the user's information database at the affiliated web site; and
updating the user's information database based on the information related to the user decoded from the ticket, if either the user is a new user or the information in the user information database at the affiliated web site is different from the information related to the user decoded from the ticket.
